(19) United States
(12) Patent Application Publication
(10) Pub. No.: US 2010/0218957 A1
(43) Pub. Date: Sep. 2, 2010

(54) Fire Extinguishing Device and Extinguishing Head

(76) Inventors: Ludomir Duda, Magdalenka (PL); Antoni Tamogrodzki, Warsaw (PL); Zygmunt Lada, Nowa Iwiczna (PL)

Correspondence Address: FAIER & FAIER P.C., 566 W. ADAMS ST., SUITE 600, CHICAGO, IL, 60661, US

(21) Appl. No.: 11/916,656

(22) PCT Filed: May 29, 2006
(86) PCT No.: PCT/PL2006/000037

§ 371 Date: Feb. 26, 2010

(30) Foreign Application Priority Data
Jun. 5, 2005 (PL) P.375521

(51) Int. Cl. A62C 31/02

(52) U.S. Cl. 169/14

(57) ABSTRACT

The fire extinguishing device is equipped with double-flow extinguishing head including side and central header, water pump /P/ connected to an extinguishing liquid source, particularly to water tank /W1/, auxiliary tank /W2/ including the proportioning system, particularly for foaming agent, connected to the water pump /P/ circuit, compressor /S/, and a dual-line fire-hose whose water-line is connected to the side header and delivery side of the water pump /P/ and the gas-line is connected to the central header and the compressor /S/. The water pump /P/ is connected to hose water-line through two-way shut-off valve /Z4/, whose second pass is connected, by connecting conduit, to the fire-hose gas-line through the first non-return valve /ZZ1/ and foam mixer /M/. The foam mixer /M/ and gas-line are connected to the circuit of compressor /S/ through shut-off valves /Z5, Z6/. Moreover the outlet of extinguishing head is furnished with at least one inner gas-nozzle of convergent-divergent profile and inner water-gap of annular cross-section formed by a sleeve /4/ situated coaxially around the inner gas-nozzle.

The extinguishing head has a double-flow body /7/ including water and gas header, inner gas-nozzle of convergent-divergent profile and inner water-gap of annular cross-section formed by a sleeve /4/ situated coaxially around the inner gas-nozzle. The inner water-gap, formed by the sleeve /4/, has at its outlet a water-nozzle situated at an angle from 0° to 45°, preferable divergently, towards to the inner gas-nozzle axis and the sleeve /4/ makes an inner part of the second gas-nozzle /2/ of convergent-divergent profile and annular cross-section situated coaxially towards to the inner gas-nozzle.

In other version of the head the inner water-gap, formed by the sleeve /4/, has at its outlet a water-nozzle situated divergently at not over 45° angle towards to the inner gas-nozzle axis and the inner gas-nozzle creates the first gas-nozzle /1′/of annular cross-section with coaxially situated inner element /6/. The inner element /6/ is ended at the nozzle outlet with conical surface divergent at an acute angle towards to the inner gas-nozzle axis.

### CLAIM OF PRIORITY

Pursuant to 35 U.S.C. 371, this application is an United States national phase filing of International Application number PCT/PL2006/000037 filed under the Patent Cooperation Treaty on 29 May 2006, which claims priority from Polish application P-375521 PL filed on 5 Jun. 2005. These cited priority documents are incorporated by reference in their entireties.

### FIELD OF INVENTION

The subject of invention is fire extinguishing device and extinguishing head to be applied in stationary systems and fire extinguishing cars with application of various extinguishing media and particularly water mist.

### BACKGROUND AND DESCRIPTION OF THE RELATED ART

The majority of fires, with exclusion for vapours-burning liquids-fires, generate fire-expanding pyrolisis gases and glowing combustible solid material. Extinguishing of such fire proceeds in two stages. Gas phase (flames) is extinguished in the first stage. Burning solid materials are cooled down and their extinguishing is completed in the second stage. While application of water mist of relatively low cooling capability is extremely efficient in the first stage, high extinguishing capability and thus high water amount as cooling down agent is required to cool down and extinguish glowing solid combustible material of radically higher heat capacity.

Fire extinguishing devices and systems with water mist application, equipped with at least one water tank, water pump to supply fire-hose nozzle and compressor are well-known. Water and compressed air is fed through dual-line fire-hose to the extinguishing head with the possibility of water and airflow adjustment where production of water mist or compact water stream is selected contingently upon a need.

Fire extinguishing device with water tank connected to the compressed air tank is presented in patent specification PL 188681. Water under pressure, with possible foaming agent additive, is delivered through one branch-ended line with two delivery channels to nozzle head whose discharging nozzle is adapted to water and water mist extinguishing and with foam nozzle. At the branch point is placed a reversing valve for selectively closing the first or the second delivery channel completely or partly in order to deliver extinguishing medium to selected nozzle according to the needs.

Hitherto used extinguishing equipment with application of water mist reveals essential problems related to difficulties in obtaining appropriate kinetic energy of drops stream. It is the important issue since the lower is drops weight the higher is mist quality. In order to obtain sufficiently low drops diameter the stream has to flow out through very small openings or to be broken in dispersing equipment, which requires very high pressures to be produced by pumps in suction circuit. Minute drops weight makes however impossible to produce water mist of sufficient kinetic energy in respect of extinguishing properties. This problem was solved in Polish patent specification number P.368269 regarding double-flow water-mist producing head by application of two convergent-divergent coaxial nozzles and annular, situated concentrically between the nozzles, water-gap convergent towards to the nozzles axis. This solution is based on generation of drops kinetic energy in the process of gas-dynamic mist production by air stream accelerated to the speed 2÷3M. In result much higher reach of water mist stream was obtained, however the mist stream generated was of expressly lower mist density in the middle part what was manifested by disadvantageous local rise of flame temperature in the case of solid bodies extinguishing. Additionally, the section of mist stream at the distance up to 4 m from the head front was characterised with very high drops concentration, which is especially disadvantageous in the case of liquids extinguishing as well as in applications where the head is used as an element of stationary extinguishing equipment.

A disadvantage of hitherto existing solutions is limited possibility of different extinguishing-media application with the help of the same nozzles in various fire phases in the case when one extinguishing device is used.

### SUMMARY OF THE INVENTION

The solution objective is development of an extinguishing device equipped with exchangeable extinguishing heads that are suitable to extinguish fires of various classes with application, depending on the need and fire phase, differentiated extinguishing media: water, water mist, de-ionized water, water solutions of freely soluble metal or ammonium salts, water and halon substitutionals mixture as well as compressed foams.

Fire extinguishing device equipped with double-flow extinguishing head including side and central header, water pump connected to extinguishing liquid source, particularly to a water tank, auxiliary tank including proportioning system, particularly for foaming agent, connected to water pump circuit, compressor, and a dual-line fire-hose whose water-line is connected to the side-header of the extinguishing head as well to a water pump from the delivery side, and gas-line is connected with central header and compressor, according to the invention is characterised in that the water pump is connected to the hose water-line through two-way shut-off valve, whose second pass is connected, by connecting conduit, to the fire-hose gas-line through the first non-return valve and a foam mixer. The foam mixer and the gas-line are connected to the compressor circuit through shut-off gas valves. The extinguishing head outlet is furnished with at least one inner gas-nozzle of convergent-divergent profile and inner water-gap of annular cross-section formed by a sleeve, which is situated coaxially around the inner gas-nozzle. Water-gap outlet can be furnished with water-nozzle situated at 0° to 45° angle, preferable divergently, towards to the inner gas-nozzle axis.

### ADVANTAGES OF THE INVENTION

It is advantageous if the sleeve is an inner part of second gas-nozzle of convergent-divergent profile and annular cross-section, situated coaxially towards to the inner gas-nozzle.

It is also advantageous if the second gas-nozzle is situated coaxially inside a second sleeve, which creates outside water-gap of annular cross-section and the second sleeve makes an inner part of the third gas-nozzle of convergent-divergent profile situated coaxially towards to the inner gas-nozzle. In the case of this solution it is advantageous if the third gas-nozzle as well as outside water-gap outlets are situated at the end of a diffuser formed by their outside walls and outside water-gap, formed by the second sleeve, has at its outlet a water-nozzle situated at 0° to 45° angle, preferable divergently, towards to the inner gas-nozzle axis.

Inner gas-nozzle of the device can be designed in a form of circular nozzle or in a form of the first gas-nozzle of annular cross-section whose inner element end is in a form of conical surface divergent at an angle of not over 45° towards to this nozzle axis. Also such solution is suitable where the second and the third gas-nozzles cross-section axes are deflected divergently at an angle of not over 45° towards to the inner gas-nozzle axis.

Advantageous device realization is characterised with extinguishing head of two-position two-way shut-off valve changeover switch and gas shut-off valves connected with the compressor through the second non-return valve. The first gas shut-off valve closes the sideline to the foam mixer and the second gas shut-off valve closes the gas-line between the connecting line and the second non-return valve.

The extinguishing head having double-flow body including water and gas header, inner gas-nozzle of convergent-divergent profile as well as inner annular cross-section water-gap formed by a sleeve situated coaxially around the inner gas-nozzle, according to the invention is characterised in that the inner water gap, formed by the sleeve, has at its outlet a water-nozzle situated at 0° to 45° angle, preferable divergently, towards to the inner gas-nozzle axis. Additionally the sleeve makes an inner part of the second gas-nozzle of convergent-divergent profile and annular cross-section situated coaxially towards to the inner gas-nozzle.

It is advantageous if the second gas-nozzle is situated coaxially inside the second sleeve that creates an outside water-gap of annular cross-section and the second sleeve makes an inner part of the third gas-nozzle of convergent-divergent profile situated coaxially towards to the inner gas-nozzle. It is advantageous if the third gas-nozzle end section axis is deflected divergently at an angle of not over 45° towards to the inner gas-nozzle axis and additionally the third gas-nozzle and outside water-gap outlets are at the end of the diffuser formed by their outside walls. This solution includes outside water-gap, formed by the second sleeve, having at its outlet a water-nozzle which is situated at 0° to 45° angle, preferable divergently, towards to the inner gas-nozzle axis and the second gas-nozzle end-section axis is deflected divergently at an angle of not over 45° towards to the inner gas-nozzle axis.

Inner gas-nozzle of the extinguishing head can be designed in a form of circular nozzle or in a form of the first gas-nozzle of annular cross-section where inner element is ended at the nozzle outlet with divergent conical surface at an angle of not over 45° towards to inner gas-nozzle axis.

Other fire extinguishing device having double-flow body including water and gas header, inner gas-nozzle of convergent-divergent profile as well as inner water-gap of annular cross-section formed by a sleeve situated coaxially around the inner gas-nozzle, according to the invention is characterised in that the inner water-gap, formed by the sleeve, has at its outlet a water-nozzle situated divergently at an angle not over 45° towards to the inner gas-nozzle axis and the inner gas-nozzle constitutes the first gas-nozzle of annular cross-section with coaxially situated inner element. Additionally the inner element is ended at the nozzle outlet with conical surface divergent at acute angle towards to the inner gas-nozzle axis.

The solution according to the invention makes possible to obtain uniform stream of highly dispersed water mist or water as well as water foam (below 200 μm) at the extinguishing head outlet with application of the same extinguishing head. An advantage of the device is also a possibility to connect additional tanks or to connect it to a draw point as well as a possibility to control the distribution valve by a changeover switch situated at the extinguishing head.

Extinguishing head according to the invention makes possible to generate water mist stream of uniform conical shape maintaining considerable reach at the same time. Application of water-gaps between convergent-divergent nozzles provides gas-dynamic mist production of high dispersion grade directly at the head outlet. Appropriate angle differentiation of gas-nozzles throats end sections and nozzles end sections position makes possible to obtain extinguishing medium stream of various dispersion angle.

Additional gas-nozzles situated concentrically towards to the inner gas-nozzle make possible to increase extinguishing medium dispersion grade and its reach. The reach can be also increased with the help of a diffuser application. Application of a circular nozzle as the inner gas-nozzle makes possible to increase extinguishing medium reach and flow rate.

### BRIEF DESCRIPTION OF THE DRAWINGS

The solution according to the invention is illustrated by an realization example where

FIG. 1 presents the construction of extinguishing device in schematic simplification,

FIG. 2 presents axial section of the extinguishing head including circular nozzle and annular water-gap,

FIG. 3 presents axial section of the extinguishing head including three gas-nozzles and two water-gaps,

FIG. 4 presents axial section of the extinguishing head furnished with two gas-nozzles of annular cross-section including water-nozzles situated parallel to the gas-nozzles axis,

FIG. 5 presents axial section of the extinguishing head furnished with two gas-nozzles of annular cross-section and inner water-gap including water-nozzle situated divergently towards to the inner gas-nozzle axis.

### DETAILED DESCRIPTION OF THE PREFERRED EMBODIMENT

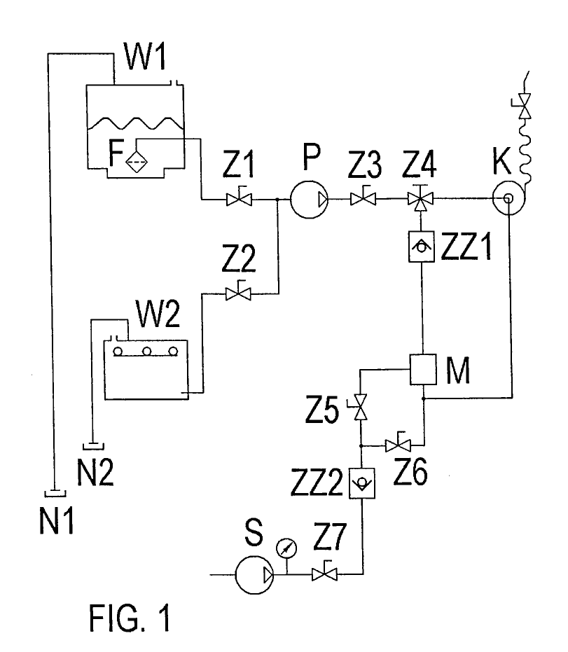

As presented at FIG. 1, fire extinguishing device is equipped with double-flow extinguishing head including side and central header, water pump P connected to the water tank W1, auxiliary tank W2 including foaming agent proportioning system connected to the water pump P circuit, compressor S, dual-line fire-hose of “hose-in-hose” type and winder K. One end of the hose water-line is connected to the side header of the extinguishing head and the other to the water pump P at the delivery side. One end of the gas-line is connected to the central header of extinguishing head and the other to the compressor circuit. Water pump P is connected to the fire-hose water-line through the first passage of two-way shut-off valve Z4. The other passage of this valve is connected, by connecting line, with fire-hose gas-line through the first non-return valve ZZ1 and the foam mixer M. Air inlet of designated for compressed foam production foam mixer M is connected to the compressor by a sideline. Foam mixer M and gas-line are connected to the circuit of compressor S through shut-off valves Z5, Z6 and the second non-return valve ZZ2. The first gas shut-off valve Z5 is situated on sideline to the foam mixer M and the second gas shut-off valve Z6 is situated on the gas-line between the connecting line and the second non-return valve ZZ2. The first non-return valve closes connection of connecting line to the water pump P. The second non-return valve ZZ2 closes connection of connecting line with the compressor S. A connection with first attachment N1 to connect water tank W1 with water draw point is provided at the suction side of water pump P. Other connection to the second attachment N2 provides filling of the auxiliary tank W2. Water tank W1 is equipped with filter F.

Stop valves Z1 and Z2 at the suction side of the water pump P make possible to disconnect a selected tank and its replacement as well as flow control from water tanks W1, W2 to the pump P. Non-return valves ZZ1, ZZ2 protect compressing machinery against undesirable reverse flow effect. Main stop valve Z3 is situated at the delivery side of the water pump P.

Extinguishing head outlet is equipped with a internal gas-nozzle of convergent-divergent profile connected to the central header and also inner water-gap of annular cross-section connected to the side header. The headers are connected to separate fire-hose lines. Separate delivery ducts are provided in the extinguishing head body 7 to connect side header with respective nozzles at the head outlet. Two-position two-way shut-off valve Z4 changeover switch is attached to the head.

The first position of two-way shut-off valve Z4 opens the first valve passage. Extinguishing medium is delivered from the water tank W1 to the extinguishing head through the fire-hose water-line and compressed air is delivered through the gas-line. In effect, gas-dynamically dispersed water-mist stream is obtained at the extinguishing head outlet. A very high dispersion of water particles occurs in the time of extinguishing with water mist, maintaining at the same time compact stream-area of high kinetic energy mist at the head outlet. Mass of water mist produced by the extinguishing head consists not only of water mass but also of air mass. Owing to this, kinetic energy of mist produced rises to the extent making possible to direct front of the produced mist stream for a distance of 8-10 m, what is satisfactory distance in fire extinguishing conditions.

The second position of two-way shut-off valve Z4 directs extinguishing medium from water pump P, through the connecting line, to the foam mixer M from where it is delivered to the fire-hose gas-line. In order to produce compressed foam the shut-off valve Z1 of the water tank W1 is closed and shut-off valve Z2 of the auxiliary tank W2 with foam producing agent remains open. Compressed foam is produced in the progress of foam mixer M operation. The second shut-off valve Z6 is closed. The compressed foam produced flows through the fire-hose gas-line and next the gas-nozzles at the extinguishing head outlet decompress it.

The extinguishing medium is delivered to the extinguishing head through the gas line and dispersed by the gas-nozzles in the progress of the device operation in the second position of two-way shut-off valve Z4 but with foam mixer M switched-off and shut-off valve Z6 opened.

The device can be equipped with various extinguishing head execution-versions. In the case of stationary units the fire-hose can be replaced with a system including water and gas-lines to which extinguishing heads are connected.

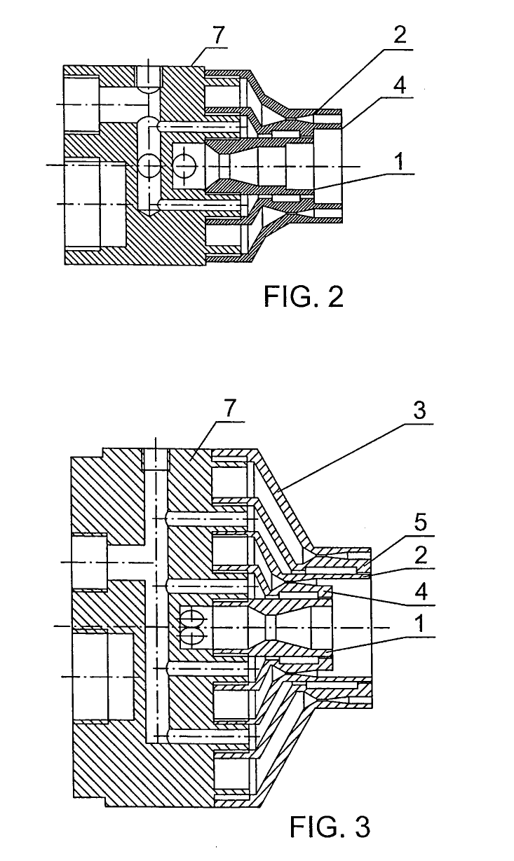

The extinguishing head presented at FIG. 2 has the body 7 including water and gas header, inner gas-nozzle of convergent-divergent profile and inner water-gap of annular cross-section formed by the sleeve 4 situated coaxially around inner gas-nozzle. Inner water-nozzle situated parallel towards to the inner gas-nozzle axis is arranged at the inner water-gap formed by the sleeve 4. The sleeve 4 makes an inner part of the second gas-nozzle 2 of convergent-divergent profile and annular cross-section situated coaxially towards to the inner gas-nozzle. End section axis of the gas-nozzle 2 at the divergent nozzle part outlet is situated parallel towards to the inner gas-nozzle axis. Circular nozzle 1 makes the inner gas-nozzle.

FIG. 3 presents realization of the extinguishing nozzle including three gas-nozzles. The head is furnished with a circular nozzle 1 and inner water-gap of annular cross-section formed by the sleeve 4 situated coaxially around the circular nozzle 1. The sleeve 4 constitutes an inner part of the second gas-nozzle 2. This nozzle is situated coaxially inside the second sleeve 5, which forms the outside water-gap of annular cross-section, where the second sleeve 5 makes an inner part of the third gas-nozzle 3 of convergent-divergent profile and situated coaxially towards to the inner gas-nozzle. This solution foresees all nozzles with the walls parallel to the axis of the circular nozzle 1 at outlet. Additionally the third gas-nozzle 3 as well as outside water-gap have outlets arranged at the end of a diffuser formed by their outside walls.

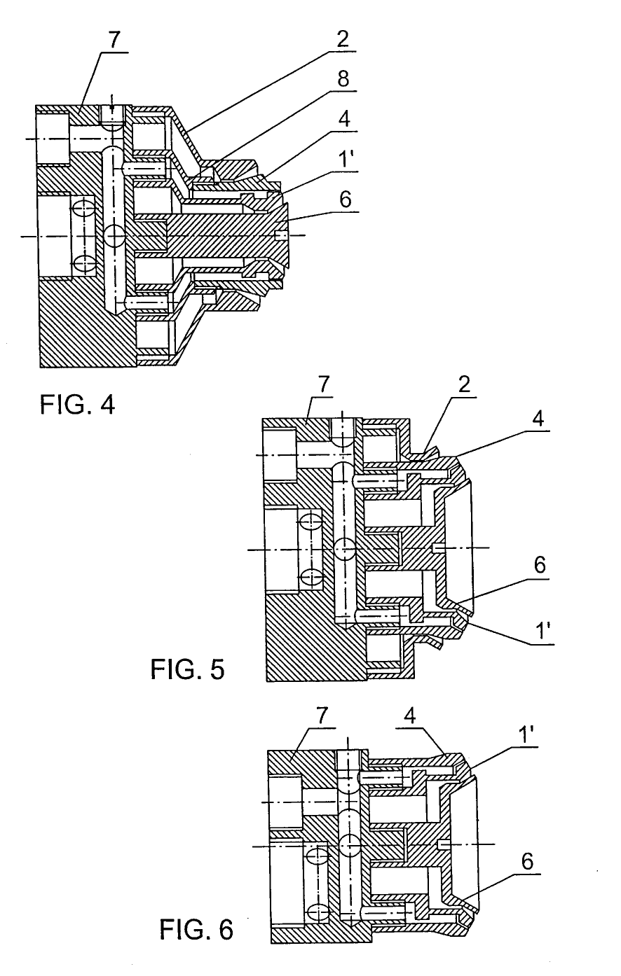

FIG. 4 presents other realization of the head where the inner gas-nozzle makes the first gas-nozzle 1′ of annular cross-section and the inner element 6 at the nozzle outlet is ended with conical area that is divergent at about 30° angle towards to the axis of the first gas-nozzle 1′. Additionally the inner water-gap is furnished with a water-nozzle situated parallel towards to the axis of the first gas-nozzle 1′, and final cross-section axis of the second gas-nozzle 2 is divergent at about 30° angle towards to the inner gas-nozzle axis. Connection of the sleeve 4 with the body 7 through an intermediate part 8 is applied in this nozzle.

FIG. 5 presents other version of the head realization including two situated concentrically gas-nozzles—the first 1′ and the second 2—every of which has the end section axis divergent at about 30° angle towards to the inner gas-nozzle axis and the water-nozzle at the water-gap outlet is divergent at the same angle.

FIG. 6 presents other extinguishing head of double-flow body 7 including water and gas header of convergent-divergent profile and inner water-gap of annular cross-section formed by the sleeve 4 situated coaxially around inner gas-nozzle. The inner water nozzle formed by sleeve 4 has at the outlet a water-nozzle situated divergently in relation at the inner gas-nozzle axis at an angle not over 45° at the outlet of water-gap formed by the sleeve 4. The inner gas nozzle, formed by the sleeve 4, makes the first gas-nozzle 1′ of annular cross-section including coaxially situated inner element 6. Inner element 6 is ended at the nozzle outlet with divergent surface at acute angle towards to the inner gas-nozzle axis.

Water-gaps outlets can be ended with water-nozzle of the walls parallel to inner gas-nozzle axis or of convergent walls depending on extinguishing heads realization. These nozzles can be situated at an angle from 0° to 45° towards to inner gas-nozzle axis and this angle arm determines the axis of nozzle outlet cross-section in the plane that runs through the inner nozzle axis. Water-gaps in the part before the water-nozzle can be furnished with a swirl chamber that is formed by annular throat or a recess in outside or inner water-gap wall.

Efficiency of the extinguishing device performance can be increased by application of additives, such as salt solutions and particularly NaCl, in order to raise delivered water density. Introduction of water solutions or other, less volatile than water, substances into the flame area increases flame extinguishing efficiency and evaporated solid particles that remain in the fire area provide additional smothering factor. These solutions can be prepared in auxiliary tanks, which can be easily connected to the water pump P at suction side. It is also possible to connect auxiliary tanks at the delivery side with the help of auxiliary water pumps as well as to connect the water pump P directly to the draw point.

The extinguishing device and extinguishing nozzle according to the invention can be applied in stationary systems of extinguishing devices for the purposes to protect rooms, communication and equipment lines where a determined nozzles system of various reach, dispersion and outflow direction is required. Additionally they can be applied to disperse chemical agents by water mist produced. In this case the device makes possible contaminations neutralising and washing with water in one operation cycle without the necessity to replace the extinguishing head.

While the preferred embodiments of the invention have been disclosed in considerable detail, variations based on the inventive features disclosed herein may be made within the spirit of the invention, and the scope of the invention should not be limited by the examples or to the exact construction shown or described. To properly determine the scope of the invention, an interested party should consider the claims herein, and any equivalent thereof.

The inventors claim:

1. Fire extinguishing device equipped with double-flow extinguishing head including side and central header, water pump connected to an extinguishing liquid source, particularly to water tank, auxiliary tank including the proportioning system, particularly for foaming agent, connected to the water pump circuit, compressor, and a dual-line fire-hose whose water-line is connected to the side header and delivery side of the water pump and the gas-line is connected to the central header and the compressor, characterized in that the water pump /P/ is connected to hose water-line through two-way shut-off valve /Z4/, whose second pass is connected, by connecting conduit, to the fire-hose gas-line through the first non-return valve /ZZ1/ and foam mixer /M/, and the foam mixer /M/ and gas-line are connected to the circuit of compressor /S/ through shut-off valves /Z5, Z6/, while the outlet of extinguishing head is furnished with at least one inner gas-nozzle of convergent-divergent profile and inner water-gap of annular cross-section formed by a sleeve /4/ situated coaxially around the inner gas-nozzle.

2. The device according to the claim 1, wherein the sleeve /4/ constituting an inner part of the second gas-nozzle /2/ of convergent-divergent profile and annular cross-section situated coaxially towards to the inner gas-nozzle.

3. The device according to the claim 2, wherein the second gas-nozzle /2/ is situated coaxially inside a second sleeve /5/ that forms the outside water-gap of annular cross-section, where the second sleeve /5/ makes an inner part of a third gas-nozzle /3/ of convergent-divergent profile situated coaxially towards to the inner gas-nozzle.

4. The device according to the claim 3, wherein the third gas-nozzle /3/ outlet and outside water-gap outlet are at the end of a diffuser formed by their outside walls.

5. The device according to the claim 1, wherein the inner gas-nozzle making a circular nozzle /1/.

6. The device according to the claim 1, wherein the inner gas-nozzle making the first gas-nozzle /1′/ of annular cross-section and the inner element /6/ is ended at the nozzle outlet with conical surface divergent at an angle of not over 45° towards to this gas-nozzle axis.

7. The device according to the claim 3 wherein the second /2/ and the third /3/ gas-nozzles have their end section axes deflected divergently at an angle of not over 45° towards to the inner gas-nozzle axis.

8. The device according to the claim 1 wherein the inner water gap, formed by the sleeve /4/, has at its outlet a water-nozzle situated at 0° to 45° angle, preferable divergently, towards to the inner gas-nozzle axis.

9. The device according to the claim 3, wherein the outside water gap, formed by the second sleeve /5/, has at its outlet a water-nozzle situated at an angle from 0° to 45°, preferable divergently, towards to the inner gas-nozzle axis.

10. The device according to the claim 1, wherein the extinguishing head has two-position changeover switch of two-way shut-off valve /Z4/.

11. The device according to the claim 1, wherein the gas shut-off valves /Z5, Z6/ are connected to the compressor /S/ through the second non-return valve /ZZ2/, and the first shut-off valve /Z5/ closes the sideline to the foam mixer /M/ and the second shut-off valve /Z6/ closes the gas line between the connecting line and the second non-return valve /ZZ2/.

12. The extinguishing head having a double-flow body including water and gas header, inner gas-nozzle of convergent-divergent profile and inner water-gap of annular cross-section formed by a sleeve situated coaxially around the inner gas-nozzle, characterized in that the inner water-gap, formed by the sleeve /4/, has at its outlet a water-nozzle situated at an angle from 0° to 45°, preferable divergently, towards to the inner gas-nozzle axis and the sleeve /4/ makes an inner part of the second gas-nozzle /2/ of convergent-divergent profile and annular cross-section situated coaxially towards to the inner gas-nozzle.

13. The head according to the claim 12, wherein the second gas-nozzle /2/ is situated coaxially inside the second sleeve /5/ that forms the outside water-gap of annular cross-section and the second sleeve /5/ makes an inner part of the third gas-nozzle /3/ of convergent-divergent profile situated coaxially towards to the inner gas-nozzle.

14. The head according to the claim 13, wherein the third gas-nozzle /3/ has the end section axis deflected divergently at an angle of not over 45° towards to the inner gas-nozzle axis.

15. The head according to the claim 13, wherein the third gas-nozzle /3/ and outside water-gap both have outlets at the end of the diffuser formed by their outside walls.

16. The head according to the claim 12, wherein the inner gas-nozzle forms a circular nozzle /1/.

17. The head according to the claim 12, wherein the inner gas-nozzle forms the first gas-nozzle /1′/of annular cross-section and the inner element /6/ is ended at the nozzle outlet with divergent conical surface at an angle not over 45° towards to the inner gas-nozzle axis.

18. The head according to the claim 13, wherein the inner water gap, formed by the second sleeve /5/, has at its outlet a water-nozzle situated at 0° to 45° angle, preferable divergently, towards to the inner gas-nozzle axis.

19. The head according to the claim 12, wherein the second gas-nozzle /2/ has end section axis deflected divergently at an angle of not over 45° towards to the inner gas-nozzle axis.

20. The extinguishing head having o double-flow body including water and gas header, inner gas-nozzle of convergent-divergent profile as well as inner annular cross-section water-gap formed by the sleeve situated coaxially around the inner gas-nozzle characterized in that the inner water-gap, formed by the sleeve /4/ has at outlet a water-nozzle situated divergently at not over 45° angle towards to the inner gas-nozzle axis and the inner gas-nozzle creates the first gas-nozzle /1′/of annular cross-section with coaxially situated inner element /6/, and the inner element /6/ is ended at the nozzle outlet with conical surface divergent at an acute angle towards to the inner gas-nozzle axis.

21. Fire extinguishing device equipped with water pump connected to an extinguishing liquid source, particularly to a water tank, an auxiliary tank including the proportioning system, particularly for foaming agent, connected to the water pump circuit, compressor, foam mixer, double-flow extinguishing head including side and central header, and a dual-line fire-hose whose water-line is connected to the side header and delivery side of the water pump and the gas-line is connected to the central header and the compressor, characterized in that the water pump (P) is connected to the hose water-line through a two-way shut-off valve (Z4), whose second pass is connected, by connecting conduit, to the fire-hose gas-line through the first non-return valve (ZZ1) and foam mixer (M), and the foam mixer (M) and gas-line are connected to the circuit of the compressor (S) through shut-off valves (Z5, Z6), while the outlet of the extinguishing head has an inner gas-nozzle of convergent-divergent profile and an inner water-gap of annular cross-section formed by a sleeve (4) situated coaxially around the inner gas-nozzle, where the sleeve (4) constituting an inner part of a second gas-nozzle (2) of convergent-divergent profile and annular cross-section situated coaxially towards to the inner gas-nozzle, and the second gas-nozzle (2) is situated coaxially inside a second sleeve (5) that forms the outside water-gap of annular cross-section, where the second sleeve (5) makes an inner part of a third gas-nozzle (3) of convergent-divergent profile situated coaxially towards to the inner gas-nozzle.

22. The device according to the claim 1, wherein the third gas-nozzle (3) outlet and outside water-gap outlet are at the end of a diffuser formed by their outside walls.

23. The device according to the claim 1, wherein the inner gas-nozzle making the first gas-nozzle (1′) of annular cross-section and the inner element (6) is ended at the nozzle outlet with conical surface divergent at an angle of not over 45° towards to this gas-nozzle axis.

24. The device according to the claim 1, wherein the second (2) and the third (3) gas-nozzles have their end section axes deflected divergently at an angle of not over 45° towards to the inner gas-nozzle axis.

25. The device according to the claim 1, wherein the inner water gap, formed by the sleeve (4), has at its outlet a water-nozzle situated at 0° to 45° angle, preferable divergently, towards to the inner gas-nozzle axis.

26. The device according to the claim 1, wherein the outside water gap, formed by the second sleeve (5), has at its outlet a water-nozzle situated at an angle from 0° to 45°, preferable divergently, towards to the inner gas-nozzle axis.

27. The device according to the claim 1, wherein the extinguishing head has two-position changeover switch of two-way shut-off valve (Z4), and the gas shut-off valves (Z5, Z6) are connected to the compressor (S) through the second non-return valve (ZZ2), and the first shut-off valve (Z5) closes the sideline to the foam mixer (M) and the second shut-off valve (Z6) closes the gas line between the connecting line and the second non-return valve (ZZ2).

28. The extinguishing head having a double-flow body including water and gas header, inner gas-nozzle of convergent-divergent profile and inner water-gap of annular cross-section formed by a sleeve situated coaxially around the inner gas-nozzle, characterized in that the inner water-gap, formed by the sleeve (4), has at its outlet a water-nozzle situated at an angle from 0° to 45°, preferable divergently, towards to the inner gas-nozzle axis and the sleeve (4) makes an inner part of the second gas-nozzle (2) of convergent-divergent profile and annular cross-section situated coaxially towards to the inner gas-nozzle.

29. The head according to the claim 8, wherein the second gas-nozzle (2) is situated coaxially inside the second sleeve (5) that forms the outside water-gap of annular cross-section and the second sleeve (5) makes an inner part of the third gas-nozzle (3) of convergent-divergent profile situated coaxially towards to the inner gas-nozzle.

30. The head according to the claim 9, wherein the third gas-nozzle (3) has the end section axis deflected divergently at an angle of not over 45° towards to the inner gas-nozzle axis.

31. The head according to the claim 9, wherein the third gas-nozzle (3) and outside water-gap both have outlets at the end of the diffuser formed by their outside walls.

32. The head according to the claim 8, wherein the inner gas-nozzle forms a circular nozzle (1).

33. The head according to the claim 8, wherein the inner gas-nozzle forms the first gas-nozzle (1′) of annular cross-section and the inner element (6) is ended at the nozzle outlet with divergent conical surface at an angle not over 45° towards to the inner gas-nozzle axis.

34. The head according to the claim 9, wherein the inner water gap, formed by the second sleeve (5), has at its outlet a water-nozzle situated at 0° to 45° angle, preferable divergently, towards to the inner gas-nozzle axis.

35. The head according to the claim 8, wherein the second gas-nozzle (2) has end section axis deflected divergently at an angle of not over 45° towards to the inner gas-nozzle axis.
